(19) United States
(12) Patent Application Publication
(10) Pub. No.: US 2007/0050698 A1
(43) Pub. Date: Mar. 1, 2007

(54) Add-in tool and method for rendering financial data into spreadsheet compliant format

(76) Inventors: Stefan Chopin, Norwalk, CT (US); Robert Krugman, New York, NY (US)

Correspondence Address: Peter S. Canelias;Law Offices of Peter S. Canelias, Suite 2148, 420 Lexington Avenue, New York, NY, 10170, US

(21) Appl. No.: 11/214,083

(22) Filed: Aug. 29, 2005

(51) Int. Cl. G06F 17/00

(52) U.S. Cl. 715/503; 715/523

(57) ABSTRACT

The invention is a process and tool that provides a simple, streamlined method for users to convert and integrate datasets into their spreadsheet program without cutting and pasting data while increasing confidence in the accuracy of information. Through a seamless and simple interface, users can easily access online datasets by launching a series of dialog boxes that facilitate a connection to online datasets. The tool combined with XML and XBRL fundamental datasets, gives users a view of company financials and a better understanding of financial performance and future trends through a spreadsheet program, and particularly so when combined with the functionality of Microsoft® Excel.

### BACKGROUND OF THE INVENTION

The invention relates to the rendering of financial data from a reporting source into spreadsheet compliant form. In the electronic format, a file containing the financial statement is typically uncoded, meaning that there are no codes in the file specifically indicating the type of information represented by each line or column of text. In order to have the computer extract the desired information from the file, the content of the file must be identified, meaning that the various tables in the file must be recognized and the content within each table must be parsed and be broken down to their constituent parts.

Once the data is recognized and broken down, it can be normalized and manipulated. For example, the normalized data can be placed in a spreadsheet program or a database program and the performance of the company can be illustrated and analyzed by various mathematical, statistical, or financial models within the functional capabilities of the spreadsheet program. The relationship between various financial statement entries can be compared and hypothetical situations can be generated and tested. Furthermore, industry analysis can be performed as well by gathering and collating data from the financial statements of several companies. Thus, there is great incentive for identifying and parsing the content of a file containing a financial statement.

A spreadsheet is a programming tool specifically adapted to the manipulation of financial data and provides a rich programming and modeling environment using a number of tools and macros that are familiar to most users of financial data. The cells of a spreadsheet can be used to store both data and formulas for manipulating data. And, as spreadsheet functionality is improved, users familiar with the capabilities of their particular spreadsheet program become dependent on those functions. An example of the improved functionality of spreadsheet programs, U.S. Pat. No. 6,779,151 to Cahill et al., incorporated by reference herein for all purposes, provides for a spreadsheet program that will recognize new object data types, i.e., those in addition to the typical spreadsheet data types such as numbers, texts, date, Boolean and error, and storing the new object data types in the cells of the spreadsheet. There have also been inventions developed to parse data and render such data in a spreadsheet, such as U.S. Pat. No. 5,893,131 to Kornfeld for a method and apparatus for parsing data, incorporated by reference herein for all purposes, and U.S. application Ser. No. 086522, U.S. publication no. 20030037038 to Block et al. for a method for adding metadata to data, incorporated by reference herein for all purposes.

In the past, in order to obtain the utility provided by a spreadsheet with financial data such as that supplied to the U.S. Securities and Exchange Commission (SEC), a spreadsheet user would “copy and paste” the relevant information into the spreadsheet for further use and analysis. Not only was this process cumbersome and time consuming, but it also allows the introduction of data errors into the spreadsheet. And, there was no method for reversing the process from the spreadsheet program to the online data provider.

### BRIEF SUMMARY OF THE INVENTION

The XML (eXtensible Markup Language) file format is in predominate use for transmitting financial data. XBRL (eXtensible Business Reporting Language) is one of the XML language formats developed for such use. It is expected to become a global standard for financial reporting. Throughout this disclosure XBRL is used as the example of an XML language.

XBRL is an XML standard for preparing, transmitting and analyzing financial information. XBRL provides context by tagging and standardizing financial data at the most granular level possible. The invention relates to a tool designed to deliver XBRL fundamental datasets directly to a spreadsheet such as Microsoft® Excel, improving data analysis workflow. The Microsoft® Excel spreadsheet is defined here as a proprietary spreadsheet.

This tool provides a simple, streamlined method for users to integrate datasets into their workflow saving hours of traditional “cut and paste” spreadsheet work while increasing confidence in the accuracy of information. Through a seamless and simple interface, users can easily access online datasets by launching a series of dialog boxes that facilitate a connection to online datasets.

The tool combined with XML and XBRL fundamental datasets, gives users an unparalleled view of company financials and a better understanding of financial performance and future trends. Among the features and benefits of this invention, the tool, combined with the functionality of a spreadsheet, preferably Microsoft® Excel, allows users to:
Pull data directly from the spreadsheet through easy to use dialog boxes and imbedded spreadsheet data retrieval commands.
Leverage existing spreadsheet templates and models.
Access the Internet for fast retrieval of data.
Ensure that data tags are not lost through XML “Copy Paste Awareness” available in such suite programs as Microsoft Office 2003. The meta-data associated with each field follows the value as it is copied and pasted into different work books.
View data in its native form as defined by standard taxonomies associated with the datasets.
Work with fundamental data tagged with universally accepted XBRL taxonomies developed in conjunction with the AICPA.

A variety of datasets are available including fundamental data in XBRL and custom formats for all United States equities. Fundamental datasets can be natively provided by the user in a XBRL format or can be derived from the SEC filings through an automated extraction process greatly improving the quality of and time it takes to get the data to the market. The tool allows the user to open this data directly or to leverage a standard SOAP compliant web service to communicate with data servers and request datasets.

This Microsoft .NET based web service can be further integrated with custom and third party applications, including financial reporting systems, analytical tools, and proprietary systems, to enhance the capabilities of existing software investments. The invention also provides for the following objects.
The invention enables online data to be embedded directly into spreadsheet cells.
Existing templates no longer require data to be Copy and Pasted from other sources saving the user time and resources.
Custom models and templates can easily be created with the data automatically delivered via an online service, preferably the EDGAR Online, Inc. service offered under the brand name I-Metrix™.
Benchmarking models allow easy company comparisons.
Charts and graphs can be updated in real time.
Linkback to the “as reported” EDGAR filing.

The invention also has a “wizard” that provides users with a convenient easy to use interface for requesting datasets from the online service. The wizard can:
Retrieve data for companies by entering or looking up a company symbol, pulling a list of companies from a spreadsheet, or loading a comma separated list from a file.
Select annual, quarterly, and trailing twelve month data periods.
Leverage existing Microsoft Excel templates and models.

Other objects and advantages will be more fully apparent from the following disclosure and appended claims.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is schematic of the basic architecture of the invention;

FIG. 2 is a block diagram of the invention.

### DETAILED DESCRIPTION

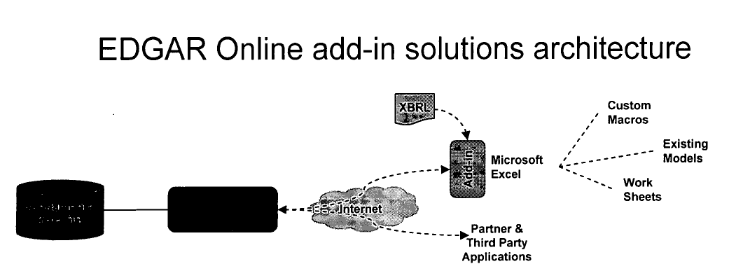

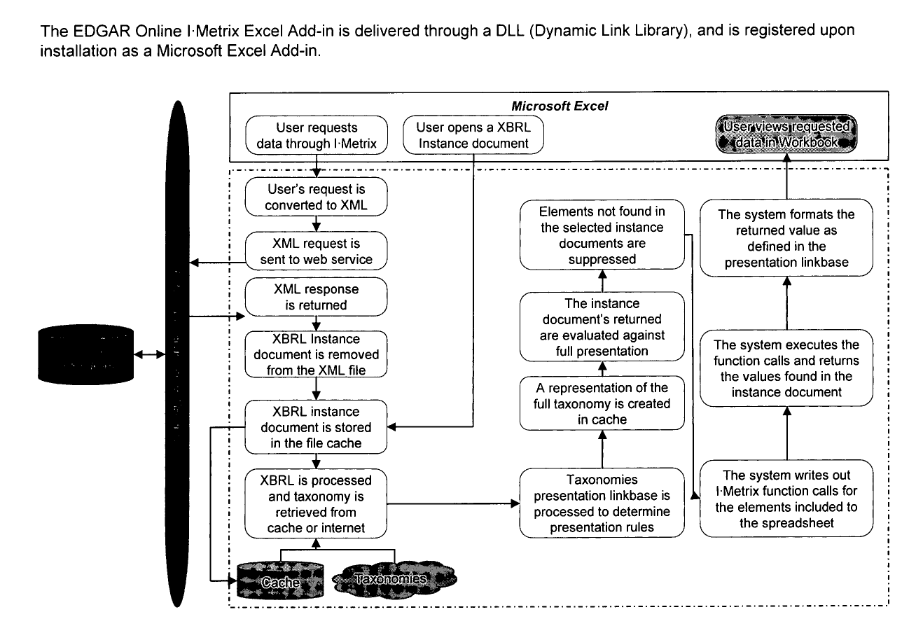

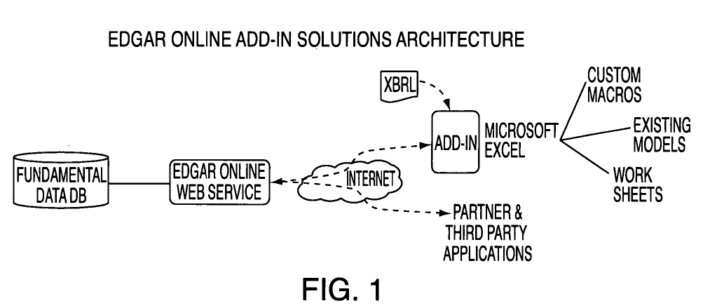

The invention renders XBRL into a spreadsheet, preferably Microsoft® Excel, though a Dynamic Link Library (DLL) the file name extension attached to a collection of library routines. As shown in FIG. 1, the overall architecture of the tool comprises a database containing fundamental data in operable engagement with an online data access service, preferably the service offered under the brand name I-Metrix™ by Edgar Online, Inc. Data flows through the online web service through a network, in this example the Internet, and as shown in the upper branch of FIG. 1 enters the add-in tool for the spreadsheet, preferably a Microsoft® Excel spreadsheet program. This bi-directional compatibility with standard XML and XBRL taxonomies allows the direct use of the functional capabilities of the spreadsheet program such as custom macros, existing models and work sheet.

Because not all companies use the same terminology, the taxonomies used by standards organizations also include synonyms and alternative phrases that have the same meaning. For example synonyms for Sales could include “Revenues” or “Fees”. Cost of Goods Sold might be “Cost of Goods” or “Cost of Sales”. Taxonomies and their extensions are used to define the Information Labels. For example in a financial report, the label <Sales>followed by a numerical value indicates that the numerical value relates to company's Sales. <Cost of Goods Sold>followed by a numerical value indicates that the value represents the company's Cost of Goods Sold. Since Gross Profit is Sales minus Cost of Goods Sold, computers could access third party reports that show these values and easily calculate the Gross Profit with a simple rule that says <Sales><minus><Cost of Goods Sold>=<Gross Profit>.

Accordingly, there is a need for methods and mechanisms to accurately and efficiently render data into XML, and in particular XBRL, compliant formats. The rendering would include, for example, converting the data as defined in relevant XBRL taxonomies. For example, within the XBRL instance document there are usually a number of name value pairs represented as <tag>value</tag>. There is also a need for methods and mechanisms to automate entry of XML and XBRL compliant data into non-XML or non-XBRL compliant programs or applications. In addition to rendering the XML and XBRL compliant data into a spreadsheet compatible format, the present invention also provides for transmitting data in a format compliant with the Simple Object Access Protocol (SOAP). Briefly, SOAP is a way for a program running in one kind of operating system to communicate with a program in the same or a different kind of operating system by using the Internet's HTTP and XML as the mechanisms for information exchange.

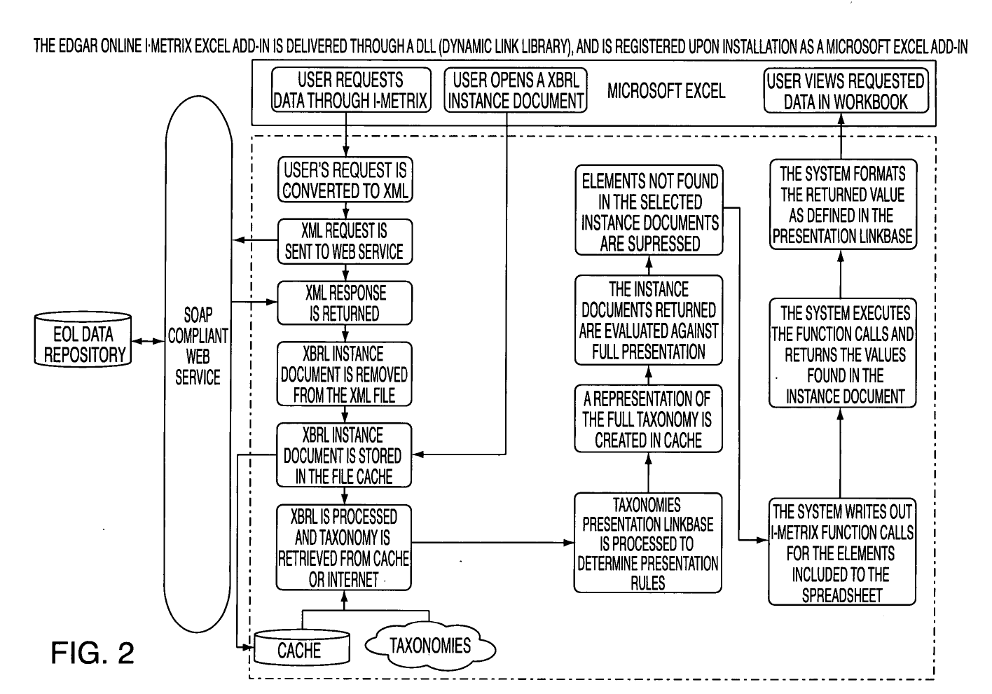

As shown in FIG. 2, the spreadsheet module is delivered through a Dynamic Link Library (DLL) and is registered upon installation as a spreadsheet add-in, here in the exemplary embodiment a Microsoft Excel Add-in. The steps involved in invoking the process of the invention are as follows.

A user may request data through an online data provider, here I-Metrix™, and the user's request is then converted to XML format. The now-converted XML request is sent to a web service, here shown as a SOAP-compliant web service linked to an EOL Data Repository. An XML response is returned, which includes a XBRL instance document comprising a dataset. An XBRL instance document is an XML document that contains a list of elements and values. This XBRL instance document is created by the backend of the invention pulling data for selected companies from the database and creating the XBRL instance document. Additionally the user may request that data from a XBRL instance document created outside of the online data provider be leveraged. Regardless of the method used to retrieve the data, the instance document will be stored as a file in the cache. The XBRL is processed and taxonomy is retrieved from cache or the Internet. A taxonomies presentation linkbase is then processed to determine a set of presentation rules. A representation of the full taxonomy is then created in cache. The instance document's elements are retrieved and evaluated against full presentation. Elements not found in the selected instance documents are suppressed. When the data in the spreadsheet is represented, the system only displays those tags and labels which are represented in the selected company's financials. For example, if a company does not report short term investments in their quarterly or annual reports, then the system will not present the label in the spreadsheet output because it is not relevant for this company. The system writes out data provider (I-Metrix™) function calls for the elements included in the spreadsheet. The system then executes the function calls and returns the values found in the instance document. The system formats the returned value as defined in the presentation linkbase. The user then views requested data in the spreadsheet, here a Workbook.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A process of converting financial data to a spreadsheet format, comprising steps of:
receiving a request for a dataset;
converting the request into a formatted message;
sending the formatted message to a web service;
receiving a formatted response, the formatted response conforming to a format;
retrieving a taxonomy associated with specifications of the format;
determining presentation rules;
evaluating the dataset against the presentation rules;
transmitting function calls for elements to be included in a target spreadsheet, and;
formatting received values compliant with the presentation rules.

2. The process of claim 1, further comprising a step of:
suppressing elements not found in the dataset.

3. The process of claim 1, further comprising a step of:
storing the dataset as a file in a cache.

4. The process of claim 1, wherein the format is an extensible business reporting language.

5. The process of claim 1, wherein the target spreadsheet is a proprietary spreadsheet.

6. A computer system, comprising a computer and a computer program executed by the computer, wherein the computer program comprises computer instructions for converting financial data to a spreadsheet format, comprising steps of:
receiving a request for a dataset;
converting the request into a formatted message;
sending the formatted message to a web service;
receiving a formatted response, the formatted response conforming to a format;
retrieving a taxonomy associated with specifications of the format;
determining presentation rules;
evaluating the dataset against the presentation rules;
transmitting function calls for elements to be included in a target spreadsheet, and;
formatting received values compliant with the presentation rules.

7. The computer system of claim 6, further comprising a step of:
suppressing elements not found in the dataset.

8. The computer system of claim 6, further comprising a step of:
storing the dataset as a file in a cache.

9. The computer system of claim 6, wherein the format is an extensible business reporting language.

10. The computer system of claim 6, wherein the target spreadsheet is a proprietary spreadsheet.

11. A process of converting financial data to a spreadsheet format, comprising steps of:
receiving a request to open a formatted document;
opening the formatted document;
retrieving a taxonomy associated with the specifications of the format;
determining presentation rules;
evaluating a dataset against the presentation rules;
transmitting function calls for elements to be included in a target spreadsheet, and;
formatting received values compliant with the presentation rules.

12. The computer system of claim 11, further comprising a step of:
suppressing elements not found in the dataset.

13. The computer system of claim 11, further comprising a step of:
storing the dataset as a file in a cache.

14. The computer system of claim 11, wherein the format is an extensible business reporting language.

15. The computer system of claim 11, wherein the target spreadsheet is a proprietary spreadsheet.

16. A computer system, comprising a computer and a computer program executed by the computer, wherein the computer program comprises computer instructions for converting financial data to a spreadsheet format, comprising steps of:
receiving a request to open a formatted document;
opening the formatted document;
retrieving a taxonomy associated with the specifications of the format;
determining presentation rules;
evaluating a dataset against the presentation rules;
transmitting function calls for elements to be included in a target spreadsheet, and;
formatting received values compliant with the presentation rules.

17. The computer system of claim 16, further comprising a step of:
suppressing elements not found in the dataset.

18. The computer system of claim 16, further comprising a step of:
storing the dataset as a file in a cache.

19. The computer system of claim 16, wherein the format is an extensible business reporting language.

20. The computer system of claim 16, wherein the target spreadsheet is a proprietary spreadsheet.
